(19) United States
(12) Patent Application Publication
(10) Pub. No.: US 2020/0255997 A1
(43) Pub. Date: Aug. 13, 2020

(54) APPARATUS FOR MANUFACTURING SUPERFINE FIBER ROLL WIPER FOR CLEANROOM

(71) Applicants: SANG IN NOH, Chungcheongbuk-Do (KR); TSP KOREA CO., LTD., Chungcheongbuk-do (KR)

(72) Inventor: Sang In NOH, Chungcheongbuk-do (KR)

(73) Assignees: TSP KOREA CO., LTD.; SANG IN NOH

(21) Appl. No.: 16/725,150

(22) Filed: Dec. 23, 2019

(30) Foreign Application Priority Data
Feb. 7, 2019 (KR) 10-2019-0014449

(51) Int. Cl. D06C 5/00; D06H 7/22; B08B 1/00

(52) U.S. Cl. CPC D06C 5/00; D04H 13/00; B08B 1/001; D06H 7/221

(57) ABSTRACT

The present disclosure provides an apparatus for manufacturing a superfine fiber roll wiper for a cleanroom, wherein a thermal cutting unit including thermal cutting blocks and thermal cutters is applied to a thermal cutting part, such that a process of manufacturing a roll wiper and a process of thermally bonding both ends of the manufactured roll wiper may be performed by the single apparatus, as a result of which, with the use of the single apparatus, it is possible to considerably improve workability, implement the mass-production, and reduce manufacturing costs. Further, the thermal cutting unit further including interval adjustment blocks in addition to the thermal cutting blocks and the thermal cutters is applied, such that a width of a roll wiper to be manufactured may be selectively and conveniently adjusted when a change in width of the roll wiper is required.

### CROSS-REFERENCE TO RELATED APPLICATIONS

This application claims priority to and the benefit of Korean Patent Application No. 10-2019-0014449 filed in the Korean Intellectual Property Office on Feb. 7, 2019, the entire contents of which are incorporated herein by reference.

### FIELD

The present invention relates to an apparatus for manufacturing a superfine fiber roll wiper for a cleanroom, and more particularly, to an apparatus for manufacturing a superfine fiber roll wiper for a cleanroom, in which a thermal cutting unit including thermal cutting blocks and thermal cutters is applied to a thermal cutting part, such that a process of manufacturing a roll wiper and a process of thermally bonding both ends of the manufactured roll wiper may be performed by the single apparatus, as a result of which, with the use of the single apparatus, it is possible to considerably improve workability, implement the mass-production, and reduce manufacturing costs, and in which the thermal cutting unit further including interval adjustment blocks in addition to the thermal cutting blocks and the thermal cutters is applied, such that a width of a roll wiper to be manufactured may be selectively and conveniently adjusted when a change in width of the roll wiper is required, as a result of which it is possible to manufacture roll wipers having various widths by using the single apparatus.

### BACKGROUND

In general, a cleanroom or clean room (hereinafter, referred to as the “cleanroom”) refers to a room in which a clean and sterile state is maintained. The cleanroom is provided as a place in which processes of manufacturing, inspecting, storing, and cleaning semiconductor wafers, devices, components, precise devices such as semiconductors, TFTs, LCDs, and cutting-edge electronic devices, and precise products. The cleanroom is required to have a very clean environment in which there is no dust in a space.

For example, during the processes performed in the controlled cleanroom, a wiper dedicated for a cleanroom is used to remove debris produced during the manufacturing process, wipe surfaces of various devices and components in the cleanroom or wipe a wall surface of the cleanroom and other surfaces in the cleanroom.

The wiper for a cleanroom is made of fibers or non-woven fabrics which are excellent in adsorbing dust particles or moisture and may inhibit the generation of dust during the use of the wiper. The wiper is manufactured and used in the form of a roll wiper made by circularly winding a wiper having a predetermined width or in the form of a rectangular wiping wiper.

In this case, the roll wiper in the related art is used to make the rectangular wiping wiper by cutting the roll wiper by using a portable roll wiper cutting device or make multiple wiping wipers by using a separate transverse cutting device.

An apparatus for manufacturing the roll wiper unwinds and conveys a large width raw fabric from a winding roll, performs thermal bonding, by using an ultrasonic device, on the large width raw fabric for each width in a width direction orthogonal to a longitudinal direction, cuts the thermally bonded portion by using a separate heating cutter, winds again the cut raw fabrics around multiple winding rolls so that the cut raw fabrics are wound in the form of rolls having predetermined widths at a predetermined interval in the longitudinal direction of the roll, and then cuts the multiple winding rolls between the multiple roll wipers wound in the form of a roll, thereby manufacturing the multiple roll wipers.

The roll wiper is finally and completely manufactured after the roll wiper manufactured through the above-mentioned processes is further manually subjected to thermal bonding at both ends in a width direction by using an ultrasonic device.

However, according to the apparatus for manufacturing a roll wiper in the related art, the ultrasonic device and the heating cutter need to additionally perform the thermal bonding process on both ends in the width direction of the raw fabric manufactured as the roll wiper to be used as the roll wiper, and the cutting process between the thermally-bonded portions. Because the separate devices are used to manufacture the roll wiper, there is a problem in that working time is increased, and workability significantly deteriorates. For this reason, there is a problem in that it is difficult to implement the mass-production, a number of people are required to operate the separate devices, and manufacturing costs are increased as the separate devices are used.

Further, the apparatus for manufacturing a roll wiper in the related art cuts the large width raw fabric to a fixed single width in the width direction, and as a result, there is a problem in that it is difficult to selectively manufacture roll wipers having various widths and efficiency in manufacturing the roll wiper deteriorates.

There is a need for research and development on an apparatus for manufacturing a roll wiper, in which a process of manufacturing a roll wiper and a process of thermally bonding both ends of the manufactured roll wiper may be performed by the single apparatus, as a result of which, with the use of the single apparatus, it is possible to considerably improve workability, implement the mass-production, and reduce manufacturing costs, and in which a width of a roll wiper to be manufactured may be selectively and conveniently adjusted when a change in width of the roll wiper is required, as a result of which it is possible to manufacture roll wipers having various widths by using the single apparatus.

### SUMMARY

The present invention has been made in an effort to provide an apparatus for manufacturing a superfine fiber roll wiper for a cleanroom, in which a thermal cutting unit including thermal cutting blocks and thermal cutters is applied to a thermal cutting part, such that a process of manufacturing a roll wiper and a process of thermally bonding both ends of the manufactured roll wiper may be performed by the single apparatus, as a result of which, with the use of the single apparatus, it is possible to considerably improve workability, implement the mass-production, and reduce manufacturing costs.

The present invention has also been made in an effort to provide an apparatus for manufacturing a superfine fiber roll wiper for a cleanroom, in which the thermal cutting unit further including interval adjustment blocks in addition to the thermal cutting blocks and the thermal cutters is applied, such that a width of a roll wiper to be manufactured may be selectively and conveniently adjusted when a change in width of the roll wiper is required, as a result of which it is possible to manufacture roll wipers having various widths by using the single apparatus.

The present invention made to achieve the above-mentioned objects will be described below. An exemplary embodiment of the present invention provides an apparatus for manufacturing a superfine fiber roll wiper for a cleanroom, in which a large width raw fabric roll made by winding, a predetermined number of times, a large width raw fabric made of a superfine fiber material around a paper tube is mounted, the large width raw fabric is conveyed in one direction, the large width raw fabric is cut into small width raw fabrics while both ends in a width direction of the large width raw fabric are subjected to thermal bonding, and small width raw fabric rolls made by winding the small width raw fabrics around paper tubes are manufactured, and the manufactured paper tubes with the small width raw fabric rolls are cut at a predetermined interval and used as multiple superfine fiber roll wipers each having a small width, the apparatus including: a large width raw fabric supply part in which the large width raw fabric roll made by winding, a predetermined number of times, the large width raw fabric made of a superfine fiber material around the paper tube is mounted, and the large width raw fabric is unwound and supplied; a tension adjustment part which adjusts tension of the large width raw fabric supplied from the large width raw fabric supply part and conveys the large width raw fabric after the large width raw fabric passes multiple conveyance guide rolls; a large width raw fabric alignment detection part which detects an alignment state of the ends in the width direction of the large width raw fabric supplied from the large width raw fabric supply part and conveyed while passing the conveyance guide rolls; a thermal cutting part which forms the multiple small width raw fabrics by thermally cutting the large width raw fabric after the large width raw fabric of which the tension is adjusted by the tension adjustment part is conveyed and guided while passing the multiple conveyance guiding rolls; a first small width raw fabric winding part in which the multiple small width raw fabrics formed by the thermal cutting part are diverged by a divergence guiding roll which rotates in a state in which an outer surface thereof is in contact with a driving roll, the small width raw fabrics in odd-numbered rows, among the multiple small width raw fabrics, are conveyed and guided, and then the small width raw fabrics are wound in multiple rows around a first paper tube and spaced apart from one another by a length of the small width raw fabric in a longitudinal direction; a second small width raw fabric winding part in which the multiple small width raw fabrics formed by the thermal cutting part are diverged by the divergence guiding roll which rotates in the state in which the outer surface thereof is in contact with the driving roll, the small width raw fabrics in even-numbered rows, among the multiple small width raw fabrics, are conveyed and guided, and then the small width raw fabrics are wound in multiple rows around a second paper tube and spaced apart from one another by the length of the small width raw fabric in the longitudinal direction; and a large width raw fabric alignment adjustment part which moves the large width raw fabric by a predetermined distance in a horizontal direction when a deviation of an alignment position is detected by the large width raw fabric alignment detection part, such that the alignment and the adjustment are performed so that the alignment position becomes normal.

In the large width raw fabric supply part, ends of connection shafts connected to both sides of a large width raw fabric winding bobbin are rotatably installed and fixed at rear upper ends of a pair of installation frames each having a horizontal movement wheel installed at a lower end thereof, any one of the connection shafts has a cooperation gear, and the connection shaft is rotated by a driving means including a driving shaft, which has, at an end thereof, a driving gear engaging with the cooperation gear, and a drive motor configured to operate the driving shaft, and the large width raw fabric is unwound and supplied from the large width raw fabric roll mounted on the large width raw fabric winding bobbin.

In addition, the tension adjustment part adjusts the tension of the large width raw fabric guided by the conveyance guide roll, which is installed at a front upper side of the pair of installation frames of the large width raw fabric supply part, among the conveyance guide rolls, such that the large width raw fabric can be conveyed and guided, and the tension adjustment part desirably includes: tension adjustment rolls having both ends which are installed at one end and the other end of fixing pieces so as to be able to idle between the fixing pieces each having a central portion axially installed to be rotatable at an upper end of each of the pair of installation frames; and a tension adjustment means including a worm gear axially connected to a center of any one of the fixing pieces, a worm engaging with the worm gear, and a handle connected to an upper end extending from a shaft of the worm in order to rotate the worm.

Further, the large width raw fabric alignment detection part is disposed above the conveyance guide roll disposed close to the large width raw fabric supply part among the conveyance guide rolls, the large width raw fabric alignment detection part detects the alignment state of the ends in the width direction of the large width raw fabric supplied from the large width raw fabric supply part and conveyed and guided by the conveyance guide rolls, and the large width raw fabric alignment detection part desirably includes: an installation rod which protrudes rearward from a center of a rear surface of any one of a pair of installation boxes having a space therebetween in which the thermal cutting part, the first small width raw fabric winding part, and the second small width raw fabric winding part are installed, the installation rod orthogonally extending by a predetermined length toward a center of the pair of installation boxes; an extension bar which has an upper end fixed to one side of the installation rod extending orthogonally and is installed to extend downward by a predetermined length; an installation block which is disposed orthogonal to a lower end of the extension bar and is fixedly installed as a block having an inverted ‘⊏’ shape, such that the end of the large width raw fabric is introduced by a predetermined length through an opened central portion; a lower detection sensor which is installed at a center of a bottom surface of an opened space of the installation block in order to detect a lower surface of the large width raw fabric introduced into the installation block; and an upper detection sensor which is installed and fixed to protrude by a predetermined length from an upper end at an opened side of the installation block in order to detect an upper surface of the large width raw fabric introduced into the installation block.

Furthermore, the thermal cutting part is installed at a front side of the large width raw fabric supply part and installed at a central portion of the pair of installation boxes installed to be spaced apart from each other at both sides at a predetermined distance so as to convey and guide the large width raw fabric, the thermal cutting part selectively moves the large width raw fabric, which is conveyed and guided by the conveyance guiding rolls, upward and downward by means of a lifting cylinder, the thermal cutting part guides a driving operation of a driving roll in one direction by means of a cutting guiding roll that rotates in a state of being in contact with the driving roll, the thermal cutting part thermally cuts the large width raw fabric into the multiple small width raw fabrics when the large width raw fabric passes the cutting guiding roll, and the thermal cutting part includes a thermal cutting unit configured to thermally cut the large width raw fabric, which passes the cutting guiding roll, into the multiple small width raw fabrics.

In this case, the thermal cutting unit desirably includes: a rotary casing which has a fixing groove recessed downward from an upper surface of the rotary casing and has both ends axially installed on inner surfaces of the installation boxes so as to be rotatable at a rear upper side of the cutting guiding roll; a predetermined number of interval adjustment blocks which are selectively inserted and fixed in the longitudinal direction in the fixing groove of the rotary casing in order to adjust a predetermined width of the small width raw fabric made by the thermal cutting; thermal cutting blocks which have lower ends inserted and fixed in the longitudinal direction in the fixing groove of the rotary casing while alternately having a predetermined interval with the interval adjustment blocks; and thermal cutters which are fixedly installed at one side of the thermal cutting blocks protruding from the rotary casing, such that when the large width raw fabric passes the cutting guiding roll, the rotary casing selectively rotates, and the thermal cutters come into contact with the cutting guiding roll to thermally cut the large width raw fabric to form the small width raw fabrics.

In addition, in the first small width raw fabric winding part, a driving shaft is rotatably and axially installed, at lateral portions thereof, inside the pair of installation boxes having the space therebetween in which the thermal cutting part is installed, an end of a first small width raw fabric winding bobbin is fixedly connected to a cooperation shaft which is connected to the driving shaft with a belt and cooperatively rotates, the portion where the driving shaft and the cooperation shaft, which are disposed at both sides of the first small width raw fabric winding bobbin, are connected with the belt is surrounded by a casing, a first paper tube having an outer surface around which the small width raw fabric is wound is mounted and fixed on the first small width raw fabric winding bobbin, and the outer surface of the first paper tube is in contact with an outer surface of a rear upper portion of the driving roll that rotates while being in contact with the divergence guiding roll.

Further, in the second small width raw fabric winding part, a driving shaft is rotatably and axially installed, at lateral portions thereof, inside the pair of installation boxes having the space therebetween in which the thermal cutting part is installed, an end of a second small width raw fabric winding bobbin is fixedly connected to a cooperation shaft which is connected to the driving shaft with a belt and cooperatively operates, guide rods configured to guide remnants remaining, after forming the small width raw fabrics, at both ends in the width direction of the large width raw fabric at both sides are disposed at positions spaced to define an “L” shape from the cooperation shaft toward the driving shaft, the portion where the driving shaft and the cooperation shaft, which are disposed at both sides of the second small width raw fabric winding bobbin and define an “L” shape together with the guide rod, are connected with the belt is surrounded by a casing, a second paper tube having an outer surface around which the small width raw fabric is wound is mounted and fixed on the second small width raw fabric winding bobbin, the outer surface of the second paper tube is in contact with an outer surface of an upper portion of the driving roll, which rotates while being in contact with the divergence guiding roll, and the upper portion of the driving roll is spaced apart from a center of a front side at a predetermined distance.

In addition, the large width raw fabric alignment adjustment part selectively moves the large width raw fabric in a horizontal direction by a predetermined distance when the deviation of the alignment position is detected by the large width raw fabric alignment detection part such that the alignment and the adjustment are performed so that the alignment position becomes normal, and the large width raw fabric alignment adjustment part desirably includes: horizontal movement wheels which are installed at front and rear sides of the lower ends of the pair of installation boxes having the space therebetween in which the thermal cutting part, the first small width raw fabric winding part, and the second small width raw fabric winding part are installed; a lower end connection frame which has both ends connected and fixed to the inner surfaces of the lower ends of the pair of installation boxes; a lower protrusion frame which protrudes while having a “U” shape angled outward from a center of the lower end connection frame; a guide rod which has both ends fixedly installed in the form of a rod between brackets installed at both sides of the lower end connection frame and spaced apart from each other at a predetermined distance; a lower connection frame which connects front lower ends of the pair of installation frames having the horizontal movement wheels installed at the lower end constituting the large width raw fabric supply part; a central installation frame which extends rearward at a rear side spaced at a predetermined distance from a center to both sides of the lower connection frame; horizontal movement guide bars which have rear ends fixed at both front sides of the lower connection frame such that the ends of the horizontal movement guide bars, which extend forward by a predetermined distance, are restrictively connected to the guide rod so as to be movable horizontally; and a horizontal movement cylinder which includes a cylinder seated and installed on an upper portion of a protruding end of the lower protrusion frame protruding from a center of the lower end connection frame, and rods connected to surfaces of the central installation frame, which extend from the lower connection frame and disposed opposite to each other, and protruding from both sides of the cylinder.

The apparatus for manufacturing a superfine fiber roll wiper for a cleanroom is desirable to further include a control unit embedded in the form of a control panel in a upper front surface of any one of the pair of installation boxes having the space therebetween in which the thermal cutting part, the first small width raw fabric winding part, and the second small width raw fabric winding part are installed, in which the control unit controls the large width raw fabric supply part, the tension adjustment part, the large width raw fabric alignment detection part, the thermal cutting part, the first small width raw fabric winding part, the second small width raw fabric winding part, and the large width raw fabric alignment adjustment part.

The effects of the apparatus for manufacturing a superfine fiber roll wiper for a cleanroom according to the present invention will be described below.

First, the thermal cutting unit including the thermal cutting blocks and the thermal cutters is applied to the thermal cutting part, such that the process of manufacturing a roll wiper and the process of thermally bonding both ends of the manufactured roll wiper may be performed by the single apparatus, as a result of which, with the use of the single apparatus, it is possible to considerably improve workability, implement the mass-production, and reduce manufacturing costs.

Second, the thermal cutting unit further including the interval adjustment blocks in addition to the thermal cutting blocks and the thermal cutters is applied, such that a width of a roll wiper to be manufactured may be selectively and conveniently adjusted when a change in width of the roll wiper is required, as a result of which it is possible to manufacture roll wipers having various widths by using the single apparatus.

### BRIEF DESCRIPTION OF THE DRAWINGS

FIG. 1 is a lateral exemplified view illustrating an apparatus for manufacturing a superfine fiber roll wiper for a cleanroom according to the present invention and illustrates a state in which a large width raw fabric roll is initially mounted on a large width raw fabric winding bobbin in order to manufacture a roll wiper.

FIG. 2 is a lateral exemplified view illustrating the apparatus for manufacturing a superfine fiber roll wiper for a cleanroom according to the present invention and illustrates a state in which a large width raw fabric is conveyed and guided from the mounted large width raw fabric roll, and small width raw fabrics are completely wound in multiple rows at a predetermined interval in a staggered arrangement around a first paper tube mounted on a first small width raw fabric winding bobbin and around a second paper tube mounted on a second small width raw fabric winding bobbin.

FIG. 3 is a main part configuration view illustrating a state viewed from a large width raw fabric supply part which is a main part in the apparatus for manufacturing a superfine fiber roll wiper for a cleanroom according to the present invention.

FIGS. 4 and 5 are main part configuration views illustrating an operational structure of a thermal cutting unit which is a main part in the apparatus for manufacturing a superfine fiber roll wiper for a cleanroom according to the present invention.

FIG. 6 is a main part configuration view illustrating an installation structure of a tension adjustment part which is a main part in the apparatus for manufacturing a superfine fiber roll wiper for a cleanroom according to the present invention.

FIG. 7 is a main part configuration view illustrating an installation structure of a large width raw fabric alignment detection part which is a main part in the apparatus for manufacturing a superfine fiber roll wiper for a cleanroom according to the present invention.

FIG. 8 is a main part configuration view illustrating a second small width raw fabric winding part including a second small width raw fabric winding bobbin on which a second small width raw fabric roll, which is a main part, is mounted in the apparatus for manufacturing a superfine fiber roll wiper for a cleanroom according to the present invention.

### DETAILED DESCRIPTION

Hereinafter, an exemplary embodiment of an apparatus for manufacturing a superfine fiber roll wiper for a cleanroom according to the present invention will be described in detail with reference to the accompanying drawings.

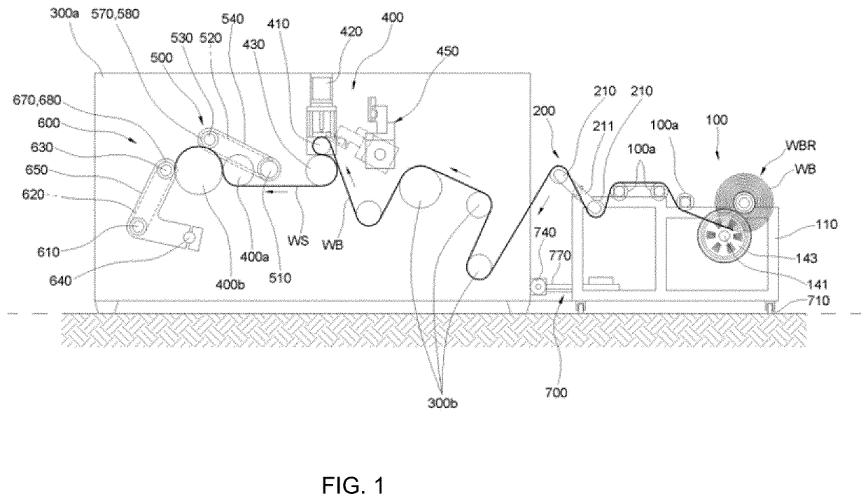

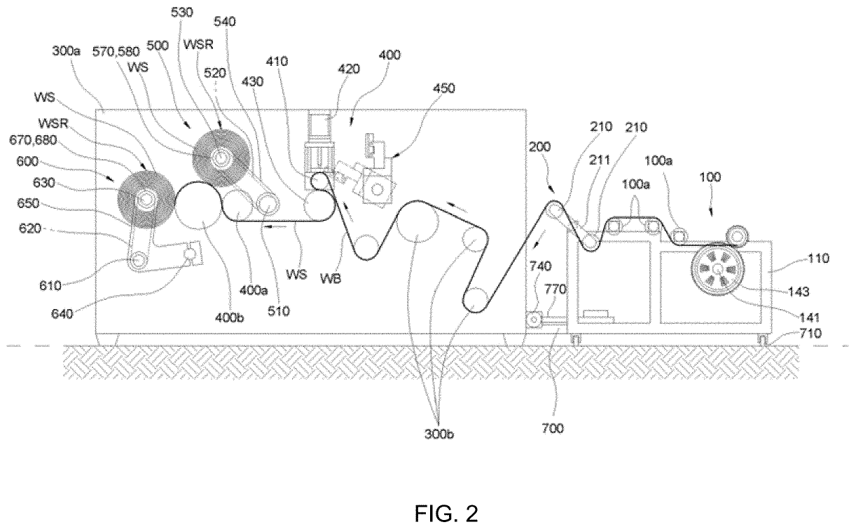

FIG. 1 is a lateral exemplified view illustrating an apparatus for manufacturing a superfine fiber roll wiper for a cleanroom according to the present invention and illustrates a state in which a large width raw fabric roll is initially mounted on a large width raw fabric winding bobbin in order to manufacture a roll wiper, and FIG. 2 is a lateral exemplified view illustrating the apparatus for manufacturing a superfine fiber roll wiper for a cleanroom according to the present invention and illustrates a state in which a large width raw fabric is conveyed and guided from the mounted large width raw fabric roll, and small width raw fabrics are completely wound in multiple rows at a predetermined interval in a staggered arrangement around a first paper tube mounted on a first small width raw fabric winding bobbin and around a second paper tube mounted on a second small width raw fabric winding bobbin.

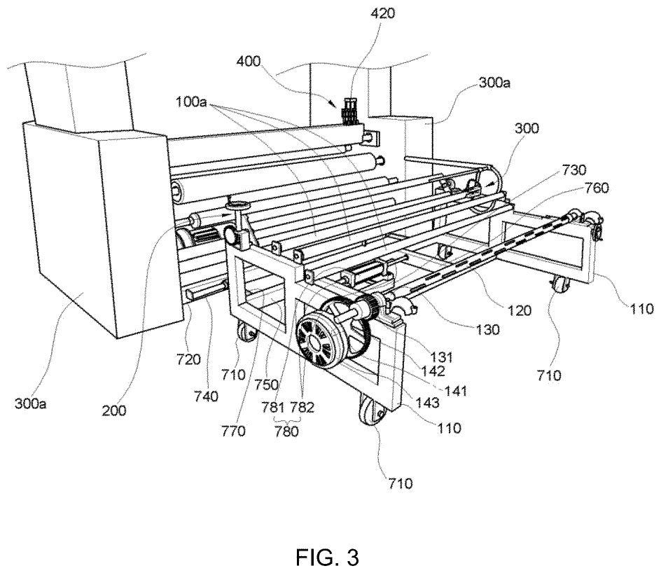

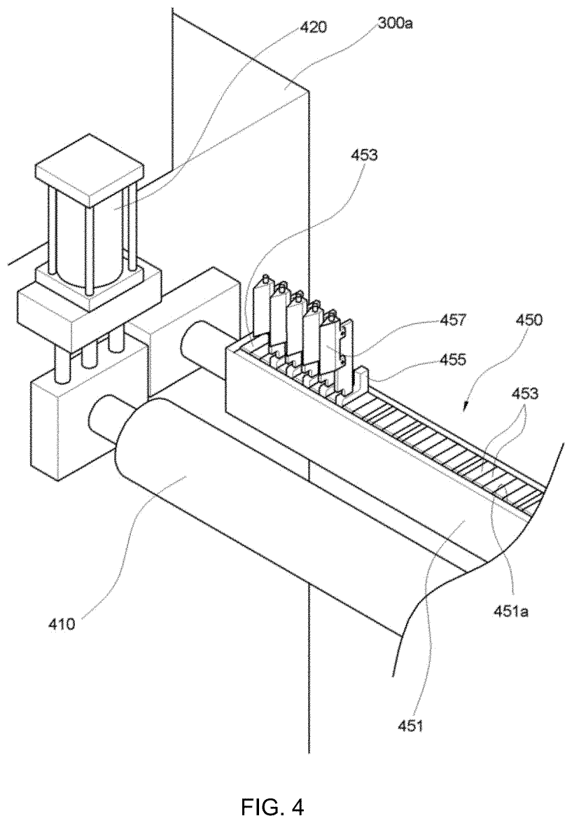

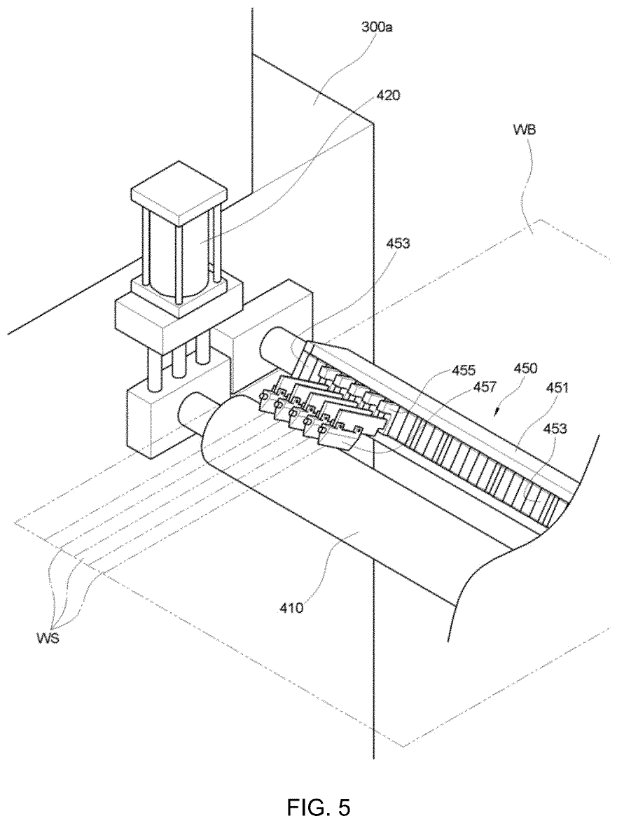

FIG. 3 is a main part configuration view illustrating a state viewed from a large width raw fabric supply part which is a main part in the apparatus for manufacturing a superfine fiber roll wiper for a cleanroom according to the present invention, and FIGS. 4 and 5 are main part configuration views illustrating an operational structure of a thermal cutting unit which is a main part in the apparatus for manufacturing a superfine fiber roll wiper for a cleanroom according to the present invention.

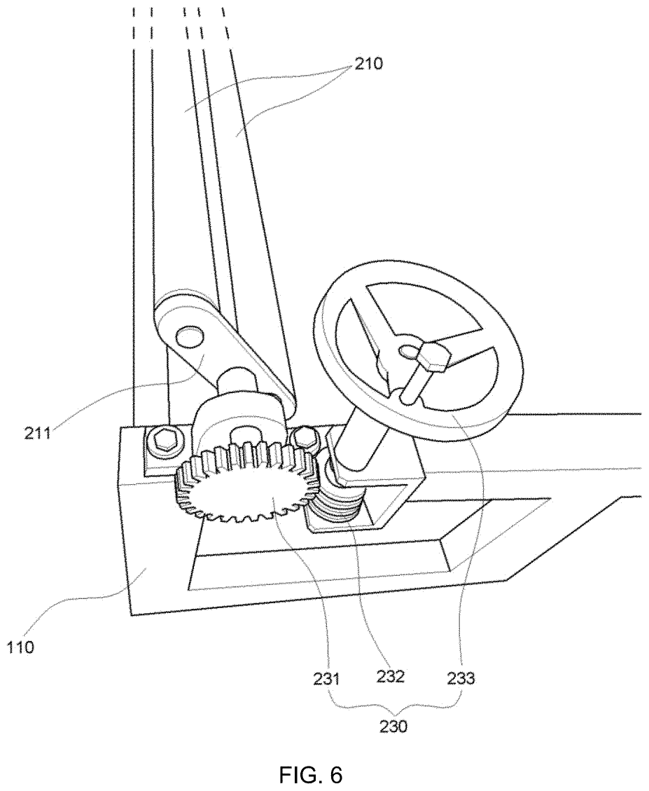

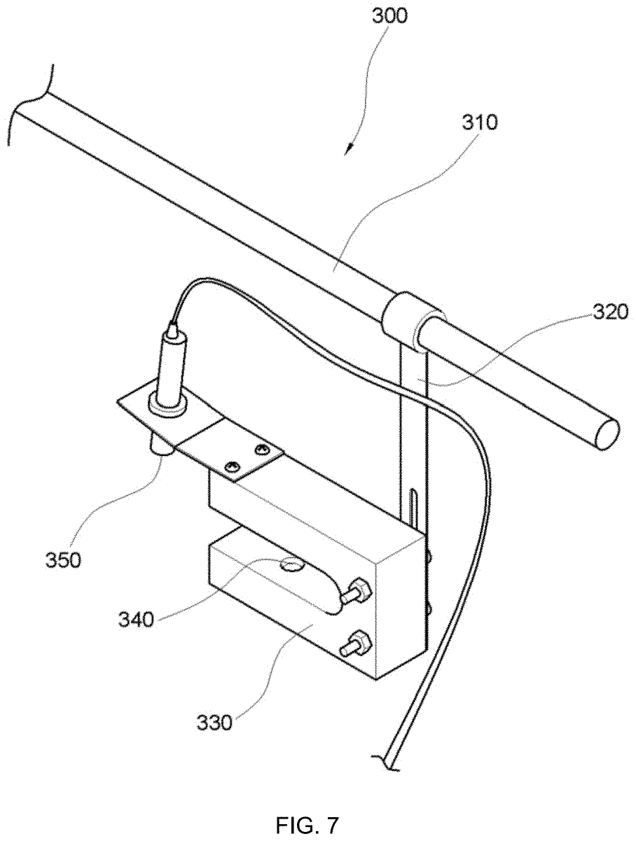

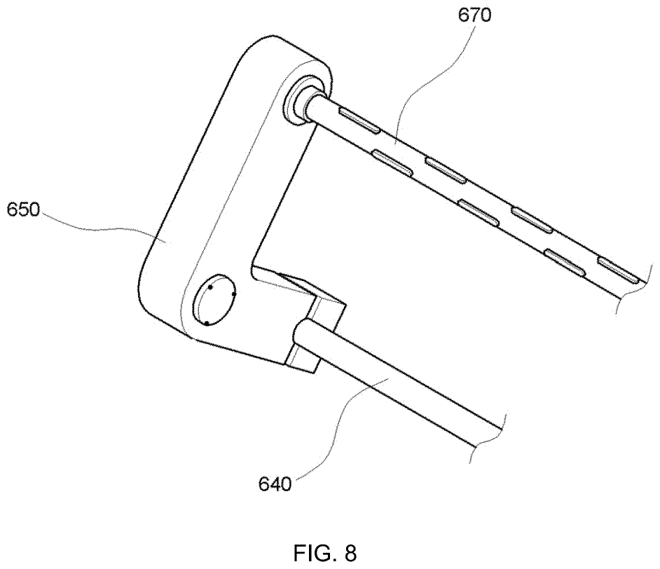

FIG. 6 is a main part configuration view illustrating an installation structure of a tension adjustment part which is a main part in the apparatus for manufacturing a superfine fiber roll wiper for a cleanroom according to the present invention, FIG. 7 is a main part configuration view illustrating an installation structure of a large width raw fabric alignment detection part which is a main part in the apparatus for manufacturing a superfine fiber roll wiper for a cleanroom according to the present invention, and FIG. 8 is a main part configuration view illustrating a second small width raw fabric winding part including a second small width raw fabric winding bobbin on which a second small width raw fabric roll, which is a main part, is mounted in the apparatus for manufacturing a superfine fiber roll wiper for a cleanroom according to the present invention.

As illustrated in FIGS. 1 to 8, the apparatus for manufacturing a superfine fiber roll wiper for a cleanroom according to the exemplary embodiment of the present invention is an apparatus in which a large width raw fabric roll WBR made by winding, a predetermined number of times, a large width raw fabric WB made of a superfine fiber material around a paper tube is mounted, the large width raw fabric WB is conveyed in one direction, the large width raw fabric WB is cut into small width raw fabrics WS while both ends in a width direction of the large width raw fabric WB are subjected to thermal bonding, thereby manufacturing small width raw fabric rolls WSR made by winding the small width raw fabrics WS around paper tubes. The manufactured paper tubes with the small width raw fabric rolls WSR are cut at a predetermined interval and used as multiple superfine fiber roll wipers each having a small width.

The apparatus for manufacturing a superfine fiber roll wiper for a cleanroom according to the present invention broadly includes a large width raw fabric supply part 100, a tension adjustment part 200, a large width raw fabric alignment detection part 300, a thermal cutting part 400, a first small width raw fabric winding part 500, a second small width raw fabric winding part 600, and a large width raw fabric alignment adjustment part 700.

Specifically, in the large width raw fabric supply part 100, the large width raw fabric roll WBR made by winding, a predetermined number of times, the large width raw fabric WB made of a superfine fiber material around the paper tube is mounted, and the large width raw fabric WB is unwound and supplied.

In addition, the tension adjustment part 200 adjusts tension of the large width raw fabric WB supplied from the large width raw fabric supply part 100 and conveys the large width raw fabric WB after the large width raw fabric WB passes multiple conveyance guide rolls 100a.

Further, the large width raw fabric alignment detection part 300 detects an alignment state of the ends in the width direction of the large width raw fabric WB supplied from the large width raw fabric supply part 100 and conveyed while passing the conveyance guide rolls 100a.

In addition, the thermal cutting part 400 forms the multiple small width raw fabrics WS by thermally cutting the large width raw fabric WB after the large width raw fabric WB of which the tension is adjusted by the tension adjustment part 200 is conveyed and guided while passing the multiple conveyance guiding rolls 300b.

Further, in the first small width raw fabric winding part 500, the multiple small width raw fabrics W2 formed by the thermal cutting part 400 are diverged by a divergence guiding roll 400a which rotates in a state in which an outer surface thereof is in contact with a driving roll 400b, the small width raw fabrics in odd-numbered rows, among the multiple small width raw fabrics W2, are conveyed and guided, and then the small width raw fabrics WB are wound in multiple rows around a first paper tube 580 and spaced apart from one another by a length of the small width raw fabric WB in a longitudinal direction.

In addition, in the second small width raw fabric winding part 600, the multiple small width raw fabrics WB formed by the thermal cutting part 400 are diverged by the divergence guiding roll 400a which rotates in the state in which the outer surface thereof is in contact with the driving roll 400b, the small width raw fabrics in even-numbered rows, among the multiple small width raw fabrics WS, are conveyed and guided, and then the small width raw fabrics WS are wound in multiple rows around a second paper tube 680 and spaced apart from one another by the length of the small width raw fabric WS in the longitudinal direction.

Further, the large width raw fabric alignment adjustment part 700 moves the large width raw fabric WB by a predetermined distance in a horizontal direction when a deviation of an alignment position is detected by the large width raw fabric alignment detection part 300, such that the alignment and the adjustment are performed so that the alignment position becomes normal.

In particular, in the large width raw fabric supply part 100 of the apparatus for manufacturing a superfine fiber roll wiper for a cleanroom according to the present invention configured as described above, ends of connection shafts 130 connected to both sides of a large width raw fabric winding bobbin 120 are rotatably installed and fixed at rear upper ends of a pair of installation frames 110 each having a horizontal movement wheel 710 installed at a lower end thereof.

In the large width raw fabric supply part 100, any one of the connection shafts 130 has a cooperation gear 131, and the connection shaft 130 is rotated by a driving means including a driving shaft 141, which has, at an end thereof, a driving gear 142 engaging with the cooperation gear 131, and a drive motor 143 configured to operate the driving shaft 141, such that the large width raw fabric WB may be unwound and supplied from the large width raw fabric roll WBR mounted on the large width raw fabric winding bobbin 120.

In addition, in the apparatus for manufacturing a superfine fiber roll wiper for a cleanroom according to the present invention configured as described above, the tension adjustment part 200 adjusts the tension of the large width raw fabric WB guided by the conveyance guide roll 100a, which is installed at a front upper side of the pair of installation frames 110 of the large width raw fabric supply part 100, among the conveyance guide rolls 100a, such that the large width raw fabric WB may be conveyed and guided.

The tension adjustment part 200 broadly includes tension adjustment rolls 210 and a tension adjustment means 230.

In more detail, both ends of each of the tension adjustment rolls 210 are installed at one end and the other end of fixing pieces 211 so as to be able to idle between the fixing pieces 211 each having a central portion axially installed to be rotatable at an upper end of each of the pair of installation frames 110.

In addition, the tension adjustment means 230 may desirably include a worm gear 231 axially connected to a center of any one of the fixing pieces 211, a worm 232 engaging with the worm gear 231, and a handle 233 connected to an upper end extending from a shaft of the worm 232 in order to rotate the worm 232.

Meanwhile, in the apparatus for manufacturing a superfine fiber roll wiper for a cleanroom according to the present invention configured as described above, it is important that the large width raw fabric alignment detection part 300 is disposed above the conveyance guide roll 100a disposed close to the large width raw fabric supply part 100 among the conveyance guide rolls 100a, and the large width raw fabric alignment detection part 300 detects the alignment state of the ends in the width direction of the large width raw fabric WB supplied from the large width raw fabric supply part 100 and conveyed and guided by the conveyance guide rolls 100a.

To this end, the large width raw fabric alignment detection part 300 broadly includes an installation rod 310, an extension bar 320, an installation block 330, a lower detection sensor 340, and an upper detection sensor 350.

Specifically, the installation rod 310 protrudes rearward from a center of a rear surface of any one of a pair of installation boxes 300a having a space therebetween in which the thermal cutting part 400, the first small width raw fabric winding part 500, and the second small width raw fabric winding part 600 are installed, and then the installation rod 310 orthogonally extends by a predetermined length toward a center of the pair of installation boxes 300a.

In addition, an upper end of the extension bar 320 is fixed to one side of the installation rod 310, which orthogonally extends, and the extension bar 320 is installed to extend downward by a predetermined length.

Further, the installation block 330 is disposed orthogonal to a lower end of the extension bar 320 and is fixedly installed as a block having an inverted ‘⊏’ shape, such that the end of the large width raw fabric WB is introduced by a predetermined length through an opened central portion.

In addition, the lower detection sensor 340 is installed at a center of a bottom surface of an opened space of the installation block 330 in order to detect a lower surface of the large width raw fabric introduced into the installation block 330.

Further, the upper detection sensor 350 is installed and fixed to protrude by a predetermined length from an upper end at an opened side of the installation block 330 in order to detect an upper surface of the large width raw fabric WB introduced into the installation block 330.

Furthermore, in the apparatus for manufacturing a superfine fiber roll wiper for a cleanroom according to the present invention configured as described above, the thermal cutting part 400 is installed at a front side of the large width raw fabric supply part 100 and installed at a central portion of the pair of installation boxes 300a installed to be spaced apart from each other at both sides at a predetermined distance so as to convey and guide the large width raw fabric WB. The thermal cutting part 400 selectively moves the large width raw fabric WB, which is conveyed and guided by the conveyance guiding rolls 300b, upward and downward by means of a lifting cylinder 420. The thermal cutting part 400 guides a driving operation of a driving roll 430 in one direction by means of a cutting guiding roll 410 that rotates in a state of being in contact with the driving roll 430. The thermal cutting part 400 thermally cuts the large width raw fabric WB into the multiple small width raw fabrics WS when the large width raw fabric WB passes the cutting guiding roll 410.

In particular, the thermal cutting part 400 includes a thermal cutting unit 450 configured to thermally cut the large width raw fabric WB, which passes the cutting guiding roll 410, into the multiple small width raw fabrics WS.

In this case, the thermal cutting unit 450 may broadly include a rotary casing 451, interval adjustment blocks 453, thermal cutting blocks 455, and thermal cutters 457.

In more detail, the rotary casing 451 has a fixing groove 451a recessed downward from an upper surface of the rotary casing 451, and both ends of the rotary casing 451 are axially installed on inner surfaces of the installation boxes 300a so as to be rotatable at a rear upper side of the cutting guiding roll 410.

In addition, the predetermined number of interval adjustment blocks 453 are selectively inserted and fixed in the longitudinal direction in the fixing groove 451a of the rotary casing 451 in order to adjust a predetermined width of the small width raw fabric WS made by the thermal cutting.

Further, lower ends of the thermal cutting blocks 455 are inserted and fixed in the longitudinal direction in the fixing groove 451a of the rotary casing 451 while alternately having a predetermined interval with the interval adjustment blocks 453.

In other words, although not specifically illustrated in the drawings, the thermal cutting blocks 455 may be inserted and fixed in the longitudinal direction in the fixing groove 451a of the rotary casing 451 alternately with the predetermined number of the interval adjustment blocks 453 from both ends to a center of a width corresponding to the width of the large width raw fabric WB.

In addition, the thermal cutters 457 are fixedly installed at one side of the thermal cutting blocks 455 protruding from the rotary casing 451. When the large width raw fabric WB passes the cutting guiding roll 410, the rotary casing 451 selectively rotates, and the thermal cutters 457 come into contact with the cutting guiding roll 410 to thermally cut the large width raw fabric WB to form the small width raw fabrics WS.

In particular, the thermal cutter 457 may be connected to a heating wire or an electric wire for applying electrical resistance and selectively heated.

That is, in the above-mentioned thermal cutting unit 450, the one or more interval adjustment blocks 453 are inserted and fixed in the fixing groove 451a of the rotary casing 451 alternately with the thermal cutting blocks 455, such that the intervals between the thermal cutters 457 may be selectively and variously adjusted when the thermal cutters 457 are used.

In other words, with the thermal cutting unit 450 configured as described above, it is possible to conveniently thermally cutting the large width raw fabric into the small width raw fabrics WS having various widths by selectively adjusting the number of interval adjustment blocks 453 so as to correspond to the width of the small width raw fabric WS which is a required width of the wiper.

Meanwhile, in the first small width raw fabric winding part 500 of the apparatus for manufacturing a superfine fiber roll wiper for a cleanroom according to the present invention configured as described above, a driving shaft 510 is rotatably and axially installed, at lateral portions thereof, inside the pair of installation boxes 300a having the space therebetween in which the thermal cutting part 400 is installed. An end of a first small width raw fabric winding bobbin 570 is fixedly connected to a cooperation shaft 530 which is connected to the driving shaft 510 with a belt 520 and cooperatively rotates. The portion where the driving shaft 510 and the cooperation shaft 530, which are disposed at both sides of the first small width raw fabric winding bobbin 570, are connected with the belt is surrounded by a casing 540.

In this case, although not specifically illustrated in the drawings, a first paper tube 580 having an outer surface around which the small width raw fabric WS is wound is mounted and fixed on the first small width raw fabric winding bobbin 570, and the outer surface of the first paper tube 580 may be in contact with an outer surface of a rear upper portion of the driving roll 400b that rotates while being in contact with the divergence guiding roll 400a.

In addition, in the second small width raw fabric winding part 600 of the apparatus for manufacturing a superfine fiber roll wiper for a cleanroom according to the present invention configured as described above, a driving shaft 610 is rotatably and axially installed, at lateral portions thereof, inside the pair of installation boxes 300a having the space therebetween in which the thermal cutting part 400 is installed. An end of a second small width raw fabric winding bobbin 670 is fixedly connected to a cooperation shaft 630 which is connected to the driving shaft 610 with a belt 620 and cooperatively operates.

In the second small width raw fabric winding part 600, guide rods 640 configured to guide remnants remaining, after forming the small width raw fabrics WS, at both ends in the width direction of the large width raw fabric WB at both sides are disposed at positions spaced to define an “L” shape from the cooperation shaft 630 toward the driving shaft 610. The portion where the driving shaft 610 and the cooperation shaft 630, which are disposed at both sides of the second small width raw fabric winding bobbin 670 and define an “L” shape together with the guide rod 640, are connected with the belt may be surrounded by a casing 650.

Further, a second paper tube 680 having an outer surface around which the small width raw fabric WS is wound is mounted and fixed on the second small width raw fabric winding bobbin 670, the outer surface of the second paper tube 680 may be in contact with an outer surface of an upper portion of the driving roll 400b, which rotates while being in contact with the divergence guiding roll 400a, and the upper portion of the driving roll 400b is spaced apart from a center of a front side at a predetermined distance.

Of course, although not specifically illustrated, the second small width raw fabric winding part 600 may have a guide bar (not illustrated) provided at an end of the guide rod 640 to guide the winding of the remnant having a ‘¬’ shape. The remnant guided by the guide rod 640 and the guide bar (not illustrated) may be wound separately from the small width raw fabric WS by a winding means (not illustrated).

In this case, the winding means (not illustrated) may include a circular plate (not illustrated) rotatably and axially installed at a lower front side where the guide rod 640 of the installation box 300a is installed, and a winding bar (not illustrated) protruding while having a predetermined interval in a circumferential direction on an one surface of the circular plate (not illustrated). The remnant may be wound around the winding bar in a circumferential direction.

Meanwhile, in the apparatus for manufacturing a superfine fiber roll wiper for a cleanroom according to the present invention configured as described above, it is important that when the deviation of the alignment position is detected by the large width raw fabric alignment detection part 300, the large width raw fabric alignment adjustment part 700 selectively moves the large width raw fabric WB in a horizontal direction by a predetermined distance, such that the alignment and the adjustment are performed so that the alignment position becomes normal.

To this end, the large width raw fabric alignment adjustment part 700 broadly includes horizontal movement wheels 710, a lower end connection frame 720, a lower protrusion frame 730, a guide rod 740, a lower connection frame 750, a central installation frame 760, horizontal movement guide bars 770, and a horizontal movement cylinder 780.

In more detail, the horizontal movement wheels 710 are installed at front and rear sides of the lower ends of the pair of installation boxes 300a having the space therebetween in which the thermal cutting part 400, the first small width raw fabric winding part 500, and the second small width raw fabric winding part 600 are installed.

In addition, both ends of the lower end connection frame 720 are connected and fixed to the inner surfaces of the lower ends of the pair of installation boxes 300a.

Further, the lower protrusion frame 730 protrudes while having a “U” shape angled outward from a center of the lower end connection frame 720.

In addition, both ends of the guide rod 740 are fixedly installed in the form of a rod between brackets installed at both sides of the lower end connection frame 720 and spaced apart from each other at a predetermined distance.

Further, the lower connection frame 750 connects front lower ends of the pair of installation frames 300a having the horizontal movement wheels 710 at the lower end constituting the large width raw fabric supply part 100.

In addition, the central installation frame 760 extends rearward at a rear side spaced at a predetermined distance from a center to both sides of the lower connection frame 750.

Further, rear ends of the horizontal movement guide bars 770 are fixed at both front sides of the lower connection frame 750, and the ends of the horizontal movement guide bars 770, which extend forward by a predetermined distance, are restrictively connected to the guide rod 740 so as to be movable horizontally.

In addition, the horizontal movement cylinder 780 includes a cylinder 781 seated and installed on an upper portion of a protruding end of the lower protrusion frame 730 protruding from a center of the lower end connection frame 720, and rods 782 connected to surfaces of the central installation frame 760, which extend from the lower connection frame 750 and disposed opposite to each other, and protruding from both sides of the cylinder 781.

That is, the horizontal movement cylinder 780 may be a bidirectional horizontal moving type cylinder to which the pair of rods 782 is applied.

In addition, although not specifically illustrated, the apparatus for manufacturing a superfine fiber roll wiper for a cleanroom according to the present invention configured as described above may further include a control unit (not illustrated) embedded in the form of a control panel in a upper front surface of any one of the pair of installation boxes 300a having the space therebetween in which the thermal cutting part 400, the first small width raw fabric winding part 500, and the second small width raw fabric winding part 600 are installed. In other words, the control unit (not illustrated) may control the large width raw fabric supply part 100, the tension adjustment part 200, the large width raw fabric alignment detection part 300, the thermal cutting part 400, the first small width raw fabric winding part 500, the second small width raw fabric winding part 600, and the large width raw fabric alignment adjustment part 700.

According to the apparatus for manufacturing a superfine fiber roll wiper for a cleanroom according to the present invention configured as described above, the thermal cutting unit including the thermal cutting blocks and the thermal cutters is applied to the thermal cutting part, such that the process of manufacturing a roll wiper and the process of thermally bonding both ends of the manufactured roll wiper may be performed by the single apparatus, as a result of which, with the use of the single apparatus, it is possible to considerably improve workability, implement the mass-production, and reduce manufacturing costs.

Further, the thermal cutting unit further including the interval adjustment blocks in addition to the thermal cutting blocks and the thermal cutters is applied, such that a width of a roll wiper to be manufactured may be selectively and conveniently adjusted when a change in width of the roll wiper is required, as a result of which it is possible to manufacture roll wipers having various widths by using the single apparatus.

While the specific exemplary embodiment of the present invention has been described in detail above, the present invention is not limited to the specific exemplary embodiment, and the present invention can be variously modified by those skilled in the art, and the modifications belong to the scope of the present invention.

What is claimed is:

1. An apparatus for manufacturing a superfine fiber roll wiper for a cleanroom, wherein a large width raw fabric roll WBR made by winding, a predetermined number of times, a large width raw fabric WB made of a superfine fiber material around a paper tube is mounted, the large width raw fabric WB is conveyed in one direction, the large width raw fabric WB is cut into small width raw fabrics WS while both ends in a width direction of the large width raw fabric WB are subjected to thermal bonding, and small width raw fabric rolls WSR made by winding the small width raw fabrics WS around paper tubes are manufactured, and the manufactured paper tubes with the small width raw fabric rolls WSR are cut at a predetermined interval and used as multiple superfine fiber roll wipers each having a small width, the apparatus comprising:
a large width raw fabric supply part in which the large width raw fabric roll WBR made by winding, a predetermined number of times, the large width raw fabric WB made of a superfine fiber material around the paper tube is mounted, and the large width raw fabric WB is unwound and supplied;
a tension adjustment part which adjusts tension of the large width raw fabric WB supplied from the large width raw fabric supply part and conveys the large width raw fabric WB after the large width raw fabric WB passes multiple conveyance guide rolls;
a large width raw fabric alignment detection part which detects an alignment state of the ends in the width direction of the large width raw fabric WB supplied from the large width raw fabric supply part and conveyed while passing the conveyance guide rolls;
a thermal cutting part which forms the multiple small width raw fabrics WS by thermally cutting the large width raw fabric WB after the large width raw fabric WB of which the tension is adjusted by the tension adjustment part is conveyed and guided while passing the multiple conveyance guiding rolls;
a first small width raw fabric winding part in which the multiple small width raw fabrics W2 formed by the thermal cutting part are diverged by a divergence guiding roll which rotates in a state in which an outer surface thereof is in contact with a driving roll, the small width raw fabrics in odd-numbered rows, among the multiple small width raw fabrics W2, are conveyed and guided, and then the small width raw fabrics WB are wound in multiple rows around a first paper tube and spaced apart from one another by a length of the small width raw fabric WB in a longitudinal direction;
a second small width raw fabric winding part in which the multiple small width raw fabrics WB formed by the thermal cutting part are diverged by the divergence guiding roll which rotates in the state in which the outer surface thereof is in contact with the driving roll, the small width raw fabrics in even-numbered rows, among the multiple small width raw fabrics WS, are conveyed and guided, and then the small width raw fabrics WS are wound in multiple rows around a second paper tube and spaced apart from one another by the length of the small width raw fabric WS in the longitudinal direction; and
a large width raw fabric alignment adjustment part which moves the large width raw fabric WB by a predetermined distance in a horizontal direction when a deviation of an alignment position is detected by the large width raw fabric alignment detection part, such that the alignment and the adjustment are performed so that the alignment position becomes normal.

2. The apparatus of claim 1, wherein in the large width raw fabric supply part, ends of connection shafts connected to both sides of a large width raw fabric winding bobbin are rotatably installed and fixed at rear upper ends of a pair of installation frames each having a horizontal movement wheel installed at a lower end thereof, any one of the connection shafts has a cooperation gear, and the connection shaft is rotated by a driving means comprising a driving shaft, which has, at an end thereof, a driving gear engaging with the cooperation gear, and a drive motor configured to operate the driving shaft, and the large width raw fabric WB is unwound and supplied from the large width raw fabric roll WBR mounted on the large width raw fabric winding bobbin.

3. The apparatus of claim 1, wherein the tension adjustment part adjusts the tension of the large width raw fabric WB guided by the conveyance guide roll, which is installed at a front upper side of the pair of installation frames of the large width raw fabric supply part, among the conveyance guide rolls, such that the large width raw fabric WB is be conveyed and guided, and the tension adjustment part comprises:
tension adjustment rolls having both ends which are installed at one end and the other end of fixing pieces so as to be able to idle between the fixing pieces each having a central portion axially installed to be rotatable at an upper end of each of the pair of installation frames; and
a tension adjustment means comprising a worm gear axially connected to a center of any one of the fixing pieces, a worm engaging with the worm gear, and a handle connected to an upper end extending from a shaft of the worm in order to rotate the worm.

4. The apparatus of claim 1, wherein the large width raw fabric alignment detection part is disposed above the conveyance guide roll disposed close to the large width raw fabric supply part among the conveyance guide rolls, the large width raw fabric alignment detection part detects the alignment state of the ends in the width direction of the large width raw fabric WB supplied from the large width raw fabric supply part and conveyed and guided by the conveyance guide rolls, and the large width raw fabric alignment detection part comprises:
an installation rod which protrudes rearward from a center of a rear surface of any one of a pair of installation boxes having a space therebetween in which the thermal cutting part, the first small width raw fabric winding part, and the second small width raw fabric winding part are installed, the installation rod orthogonally extending by a predetermined length toward a center of the pair of installation boxes;
an extension bar which has an upper end fixed to one side of the installation rod extending orthogonally and is installed to extend downward by a predetermined length;
an installation block which is disposed orthogonal to a lower end of the extension bar and is fixedly installed as a block having an inverted ‘⊏’ shape, such that the end of the large width raw fabric WB is introduced by a predetermined length through an opened central portion;
a lower detection sensor which is installed at a center of a bottom surface of an opened space of the installation block in order to detect a lower surface of the large width raw fabric introduced into the installation block; and
an upper detection sensor which is installed and fixed to protrude by a predetermined length from an upper end at an opened side of the installation block in order to detect an upper surface of the large width raw fabric WB introduced into the installation block.

5. The apparatus of claim 1, wherein the thermal cutting part is installed at a front side of the large width raw fabric supply part and installed at a central portion of the pair of installation boxes installed to be spaced apart from each other at both sides at a predetermined distance so as to convey and guide the large width raw fabric WB, the thermal cutting part selectively moves the large width raw fabric WB, which is conveyed and guided by the conveyance guiding rolls, upward and downward by means of a lifting cylinder, the thermal cutting part guides a driving operation of a driving roll in one direction by means of a cutting guiding roll that rotates in a state of being in contact with the driving roll, the thermal cutting part thermally cuts the large width raw fabric WB into the multiple small width raw fabrics WS when the large width raw fabric WB passes the cutting guiding roll, and the thermal cutting part comprises a thermal cutting unit configured to thermally cut the large width raw fabric WB, which passes the cutting guiding roll, into the multiple small width raw fabrics WS.

6. The apparatus of claim 5, wherein the thermal cutting unit comprises:
a rotary casing which has a fixing groove recessed downward from an upper surface of the rotary casing and has both ends axially installed on inner surfaces of the installation boxes so as to be rotatable at a rear upper side of the cutting guiding roll;
a predetermined number of interval adjustment blocks which are selectively inserted and fixed in the longitudinal direction in the fixing groove of the rotary casing in order to adjust a predetermined width of the small width raw fabric WS made by the thermal cutting;
thermal cutting blocks which have lower ends inserted and fixed in the longitudinal direction in the fixing groove of the rotary casing while alternately having a predetermined interval with the interval adjustment blocks; and
thermal cutters which are fixedly installed at one side of the thermal cutting blocks protruding from the rotary casing, such that when the large width raw fabric WB passes the cutting guiding roll, the rotary casing selectively rotates, and the thermal cutters come into contact with the cutting guiding roll to thermally cut the large width raw fabric WB to form the small width raw fabrics WS.

7. The apparatus of claim 1, wherein in the first small width raw fabric winding part, a driving shaft is rotatably and axially installed, at lateral portions thereof, inside the pair of installation boxes having the space therebetween in which the thermal cutting part is installed, an end of a first small width raw fabric winding bobbin is fixedly connected to a cooperation shaft which is connected to the driving shaft with a belt and cooperatively rotates, the portion where the driving shaft and the cooperation shaft, which are disposed at both sides of the first small width raw fabric winding bobbin, are connected with the belt is surrounded by a casing, a first paper tube having an outer surface around which the small width raw fabric WS is wound is mounted and fixed on the first small width raw fabric winding bobbin, and the outer surface of the first paper tube is in contact with an outer surface of a rear upper portion of the driving roll that rotates while being in contact with the divergence guiding roll.

8. The apparatus of claim 1, wherein in the second small width raw fabric winding part, a driving shaft is rotatably and axially installed, at lateral portions thereof, inside the pair of installation boxes having the space therebetween in which the thermal cutting part is installed, an end of a second small width raw fabric winding bobbin is fixedly connected to a cooperation shaft which is connected to the driving shaft with a belt and cooperatively operates, guide rods configured to guide remnants remaining, after forming the small width raw fabrics WS, at both ends in the width direction of the large width raw fabric WB at both sides are disposed at positions spaced to define an “L” shape from the cooperation shaft toward the driving shaft, the portion where the driving shaft and the cooperation shaft, which are disposed at both sides of the second small width raw fabric winding bobbin and define an “L” shape together with the guide rod, are connected with the belt is surrounded by a casing, a second paper tube 680 having an outer surface around which the small width raw fabric WS is wound is mounted and fixed on the second small width raw fabric winding bobbin, the outer surface of the second paper tube is in contact with an outer surface of an upper portion of the driving roll, which rotates while being in contact with the divergence guiding roll, and the upper portion of the driving roll is spaced apart from a center of a front side at a predetermined distance.

9. The apparatus of claim 1, wherein the large width raw fabric alignment adjustment part selectively moves the large width raw fabric WB in a horizontal direction by a predetermined distance when the deviation of the alignment position is detected by the large width raw fabric alignment detection part such that the alignment and the adjustment are performed so that the alignment position becomes normal, and the large width raw fabric alignment adjustment part comprises:
horizontal movement wheels which are installed at front and rear sides of the lower ends of the pair of installation boxes having the space therebetween in which the thermal cutting part, the first small width raw fabric winding part, and the second small width raw fabric winding part are installed;
a lower end connection frame which has both ends connected and fixed to the inner surfaces of the lower ends of the pair of installation boxes;
a lower protrusion frame which protrudes while having a “U” shape angled outward from a center of the lower end connection frame;
a guide rod which has both ends fixedly installed in the form of a rod between brackets installed at both sides of the lower end connection frame and spaced apart from each other at a predetermined distance;
a lower connection frame which connects front lower ends of the pair of installation frames having the horizontal movement wheels at the lower end constituting the large width raw fabric supply part;
a central installation frame which extends rearward at a rear side spaced at a predetermined distance from a center to both sides of the lower connection frame;
horizontal movement guide bars which have rear ends fixed at both front sides of the lower connection frame such that the ends of the horizontal movement guide bars, which extend forward by a predetermined distance, are restrictively connected to the guide rod so as to be movable horizontally; and
a horizontal movement cylinder which comprises a cylinder seated and installed on an upper portion of a protruding end of the lower protrusion frame protruding from a center of the lower end connection frame, and rods connected to surfaces of the central installation frame, which extend from the lower connection frame and disposed opposite to each other, and protruding from both sides of the cylinder.

10. The apparatus of claim 1, further comprising:
a control unit embedded in the form of a control panel in a upper front surface of any one of the pair of installation boxes having the space therebetween in which the thermal cutting part, the first small width raw fabric winding part, and the second small width raw fabric winding part are installed,
wherein the control unit controls the large width raw fabric supply part, the tension adjustment part, the large width raw fabric alignment detection part, the thermal cutting part, the first small width raw fabric winding part, the second small width raw fabric winding part, and the large width raw fabric alignment adjustment part.
